(19) United States
(12) Patent Application Publication
(10) Pub. No.: US 2011/0000185 A1
(43) Pub. Date: Jan. 6, 2011

(54) Fusion energy process

(76) Inventor: Gary Richard Gochnour, Seattle, WA (US)

Correspondence Address: Gary Richard Gochnour, 747 N. 135th St, Apt 426, Seattle, WA, 98133, US

(21) Appl. No.: 12/661,556

(22) Filed: Mar. 19, 2010

Related U.S. Application Data
(62) Division of application No. 11/728,080, filed on Mar. 23, 2007, now abandoned.
Application No. 11/728,080 is a continuation-in-part of application No. 11/137,643, filed on May 25, 2005, now abandoned.
Application No. 11/137,643 is a continuation-in-part of application No. 10/841,702, filed on May 6, 2004, now abandoned.
(60) Provisional application No. 60/468,598, filed on May 6, 2003.

(51) Int. Cl. F03H 99/00; F03H 1/00

(52) U.S. Cl. 60/203.1

(57) ABSTRACT

This invention relates to a nuclear fusion reaction process utilizing a B-11 isotope ion spherical plasma. Said spherical plasma will be formed on roof of a ferromagnetic chromium steel hulled aircraft, utilizing two larger magnesium based aircraft.

Said spherical plasma is formed by raising a pyramid shaped device with a slotted glass ball electrode on top, on roofs of said air-craft. Only the smaller craft will utilize the fusion fuels, B-11 isotope ion and H-1 atom, in forming said spherical plasmas.

The two larger craft will apply pressure toward smaller craft, and coalesce their plasmas into the smaller plasma.

By forming this induced magnetic field, an electron current existing in larger applied magnetic field, is raised to middle of smaller aircraft spherical plasma.

Ignition can be accomplished with land based neutral beam, FIG. 15. Produced energetic charged particles, electric energy, can be stored within craft plasma vortices and beamed to power stations.

### CROSS REFERENCE TO RELATED APPLICATION

This application is a division of application Ser. No. 11/728,080, filed Mar. 23, 2007, by present inventor, now abandoned, which was a continuation in part of Ser. No. 11/137,643, filed May 25, 2005 by present inventor, now abandoned, which was a continuation in part of Ser. No. 10/841,702, filed 2004, May 6, by present inventor, now abandoned, which claims the priority to provisional patent application with Ser. No. 60/468,598, filed 2003, May 6, by the present inventor.

### BACKGROUND OF THE INVENTION

### Field of Invention—Fusion Process

This invention relates to a process with a resultant B-11 isotope ion nuclear fusion reaction to obtain electric energy. Said re-action is considered a radiation free nuclear fusion reaction, with minimal danger from heat.

Negligible radiation will be produced in the fusion process, mostly charged particles.

This invention will make possible travel in space at small cost. Depletion of the world's resources will no longer be a problem. This invention is on a par with the discovery of fire, insofar as man's future is concerned.

### SUMMARY OF THE INVENTION

The fusion energy portion of this utility patent utilizes the aircraft in a fusion process.

### BRIEF DESCRIPTION OF THE DRAWINGS

FIG. 11A is a top perspective view depicting the top surface of aircraft hull, showing exit electrodes for energized, decomposed fusion fuels for formation of a B-11 isotope ion fusion spherical plasma. Also shown is an outline of the annular ring.

FIG. 11B is a side view of aircraft showing raised pyramid and ion acceleration system, and ball electrode.

FIG. 12A is a side view of three aircraft positioned to effect a B-11 isotope ion nuclear fusion reaction.

FIG. 12B is a side view of the fusion spherical plasma and two adjacent plasmas, showing directions of each individual plasma's rotation.

FIG. 12C is a top view of the induced Larmor orbiting particle plasma field, and a top view of the B-11 isotope ion spherical plasma, completely encircled now by the narrowing orbits of the induced perpendicular particle field. Extreme ignition temperature required for B-11 reaction is being approached.

FIG. 13 is a side view of three aircraft positioned to effect a B-11 isotope ion nuclear fusion reaction, close to moment of ignition of spherical plasma.

FIG. 14 is a B-11 spherical plasma between the three aircraft in the process of ignition by land based laser, and, or neutral beam, and grounded to railroad tracks and high power tension lines.

FIG. 15 shows end phase of fusion process. The produced energetic charged particles are now stored in craft rotating plasma vortices. Shown in FIG. 15 are remnant electrostatic particles and electrons and charged particles, being collected by extended rods. Said craft are shown grounded to the depicted railroad tracks.

### DESCRIPTION OF THE PREFERRED EMBODIMENT

The operation of a process portion of this patent will describe a fusion energy process utilizing said aircraft.

During a fusion process, the requirement for energized particles to be placed into mini-Larmor orbits around said ferromagnetic cores within the electrolysis system, will require, after initial formation of orbiting mini-Larmor particle fields, that the particles, primarily protons, electrons and B-11 isotope ions, have to be maintained in orbit around the ferromagnetic cores, increasing magnetic intensity of cores, and particles, as well.

At the onset of the fusion process, the cores will have increased in magnetic intensity to permit formation of the mini-Larmor orbits that will persist after the charged particles exit from roof of aircraft. The orbiting particle miniature funnels, will decompose, and the spiraling, exiting particles will coalesce into a spherical plasma, on roof of the aircraft.

The process portion of this patent pertaining to a nuclear fusion reaction utilizing the B-11 isotope ion to form a fusion spherical plasma, utilizing said aircraft 1, 1′, in said process, and further utilizing a hi-power laser or neutral beam to effect ignition of the spherical fusion plasma, can completely eliminate the source of most of the world's CO2, carbon dioxide contaminants by means of clean fusion energy.

Energy from the nuclear fusion reaction, can be beamed by microwave or other means, to nearby energy power storage facilities. At the present time, the majority of the world's electricity is generated from coal and petroleum.

### End of Description of the Preferred Embodiment

Beginning of the Operation of the Process Portion of Patent

The operation of the process portion of patent pertains to operation of a nuclear fusion reaction process utilizing said aircraft alone, or with other similar aircraft.

The following is a description of the preferred embodiment for operation of the process portion of said nuclear fusion reaction.

The fusion energy portion of this patent is a process, more specifically, it is a method for producing electricity from a nuclear fusion reaction without significant radiation produced, or cooling required to be provided.

The fuels used for this nuclear fusion reaction will be the boron B-11 isotope ion and regular hydrogen.

Said fusion process is referred to as a radiation free nuclear fusion reaction.

Negligible radiation and heat will be produced in this B-11 isotope ion nuclear fusion reaction.

Said fuels are found in borax found in nature as tincal. The state of California has approximately 200 million tons of tincal. Turkey has approximately 500 million tons of tincal. Said B-11 ion is also found in boron in seawater.

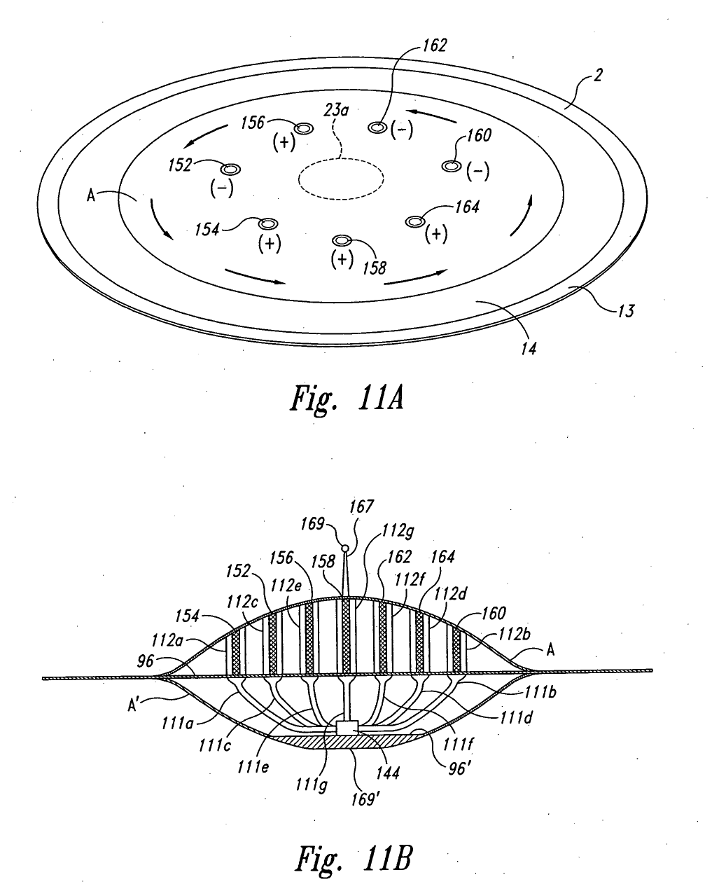

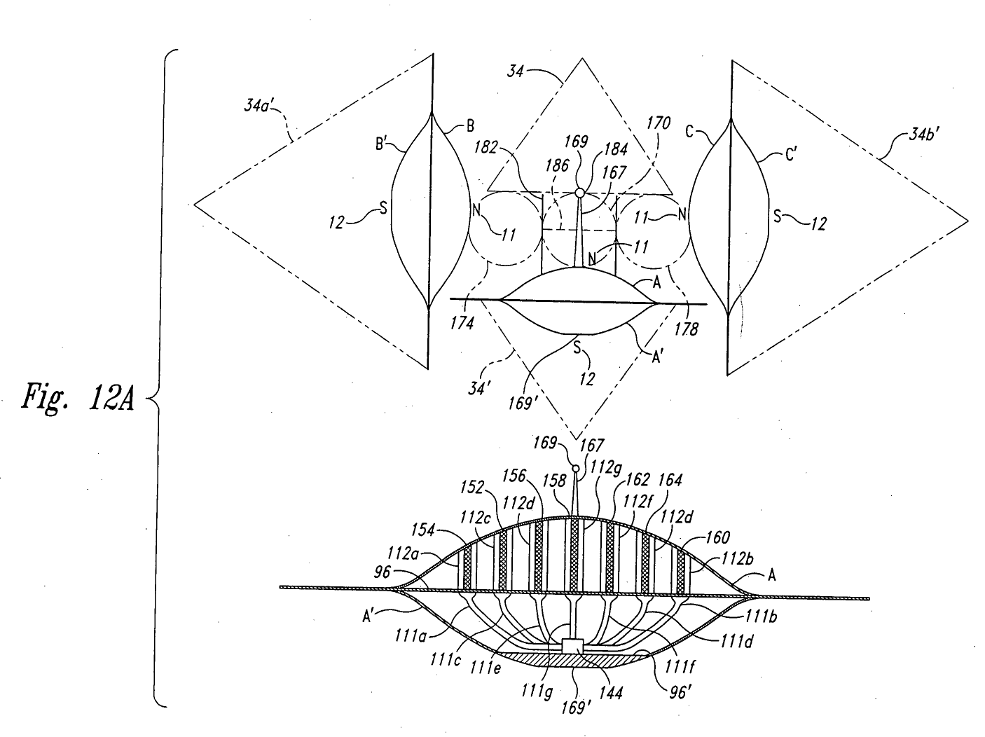

Electrode 160 and 164 are reversed in FIG. 11A as opposed to FIG. 11B. Both figures are correct, the electrode pairs will stay connected, but be physically crossed, to obtain necessary repulsive attractive charges for fusion reaction.

A brine solution will be used in vaporization process involving seawater. A boric acid solution will be used in vaporization process using borax to obtain the B-11 isotope ion for said nuclear fusion reaction. The fusion reaction is accomplished primarily by utilizing a tightening induced Larmor particle field induced by raising a ball electrode within the applied field, said applied magnetic field, already possessing an established Larmor gyro orbiting particle field. By means of inducing said smaller Larmor orbiting particle field within an induced magnetic field, within an existing magnetic field, an expanded applied magnetic field will exist, the induced magnetic field will exist within the applied magnetic field.

A vacuum 3, 3′, FIG. 1, exists under all of the rotating plasma vortices of said aircraft 1, 1′, also called device A, A′, FIG. 11B.

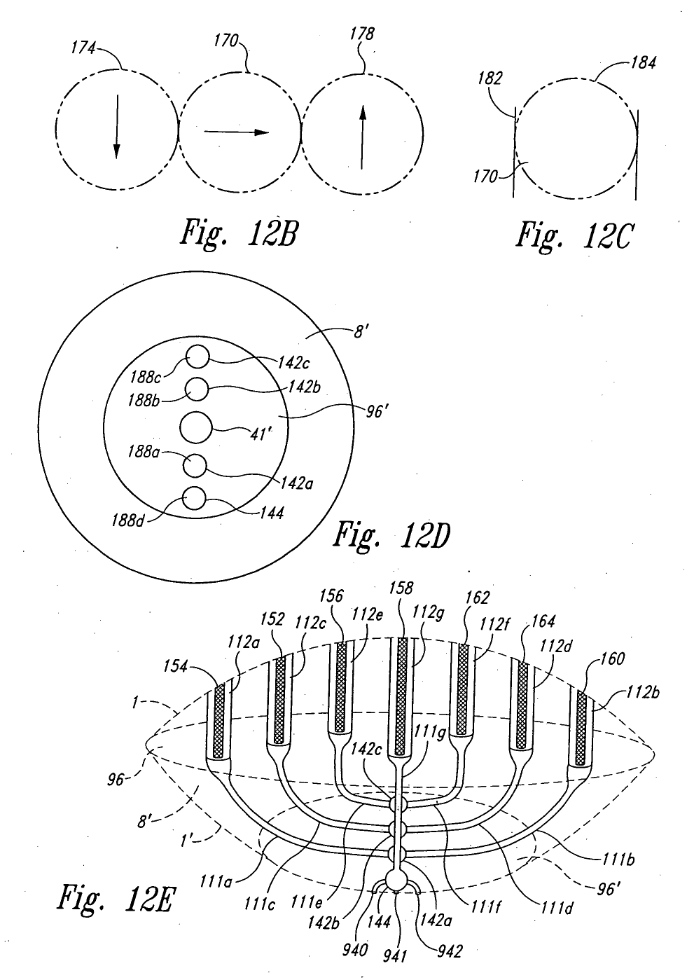

The induced Larmor orbiting particle field 184, FIG. 12A, forms around a forming fusion spherical plasma 170, FIG. 12A, on the roof of aircraft 1, 1′, FIG. 1, also called device A, A′, FIG. 12A.

By means of an on-board electrolysis system, a boron B-11 isotope fusion spherical plasma can be formed on roof of the smaller ferromagnetic aircraft. The glass ball electrode 169, FIG. 11B, can also function as an induced magnetic north pole.

Upon raising a pyramidal cone 167, FIG. 11B, with said glass ball electrode on top, an induced magnetic field is formed below the ball electrode, and an induced Larmor orbiting particle field. Over time the induced Larmor particle field will tighten around said fusion spherical plasma, increasing pressure and temperature.

The induced Larmor gyro orbiting particle field, over time, as it receives increased energy from the existing magnetic fields, said induced Larmor field will tighten around said spherical plasma, as the speed of the orbiting particles increases over time, the orbits will increasingly narrow, and tighten around the spherical plasma. The ferromagnetic aircraft 1, 1′, FIG. 1, in utility portion of this patent, will increase in energy over time, as the rotating particle fields impart increased magnetism to the ferromagnetic aircraft over time. Said energy translates into increased energy in the applied magnetic field, and the induced magnetic field, over time. The induced magnetic field receives its energy from the same source as the applied magnetic field. The induced orbiting plasma fields receive energy from the induced magnetic field.

Two larger, similar aircraft to said smaller aircraft 1, 1′, FIG. 1, are referred to as aircraft B, B′, and C, C′, in FIG. 12A, and said smaller aircraft in process portion of patent, is referred to as Device A, A′, FIG. 12A. Aircraft 1, 1′, is Device A, A′.

Arrayed perpendicular to a horizontal Device A, A′, Device B and Device C, will position their spherical plasmas, 174, and 178, FIG. 12A, on the side of fusion spherical plasma 170, FIG. 12A. Increased pressure will be applied to fusion plasma 170. In the process of expanding the applied magnetic field, there exists the fact that the applied electric field was also expanded, raised up. Now the center of the electric current cuts through said fusion plasma, to a degree, providing increased temperature. The two larger aircraft are providing increased pressure. The electron volt temperature is nearing ignition temperature. If ignition cannot be obtained spontaneously, land-based hi-power neutral beam can be used.

Referring to FIGS. 11A, 11B, 12A, depicted are elements of the fusion process utilizing apparatus for an electrolysis system. Said apparatus includes barrel shaped containers for boron B-11 isotope ions 144, FIG. 11B. Said barrel 144 of B-11 isotope ions is connected to tubular column 111g.

Laminated glass is preferred embodiment for tubular columns. The B-11 isotope ion tubular column 111g, FIG. 11B, is connected at one end to ferromagnetic cored column within a larger B-11 ion tubular column 112g, FIG. 11B. Said ferromagnetic column is connected at the other end to exit electrode 158, FIG. 11B, said electrode also called roof electrode.

Said B-11 isotope ion will exit roof electrode 158, FIG. 11A, at insulated electrode 158, having been placed into mini-Larmor gyro orbits around said ferromagnetic cored column prior to exiting electrode.

Said B-11 ion will exit roof electrode with charge indicated by positive sign located under said roof electrode designation. Direction of movement is indicated by arrows, FIG. 11A.

Said particle has been energized while rotating around said ferromagnetic column, and this has not diminished the magnetism of said ferromagnetic column, it has increased the magnetism of the cored column, as well.

Barrel 144, FIG 11B alone contains the fusion fuel boron B-11 isotope ion. Said isotope ion can be vaporized out of source prior to electrolysis procedure, or the B-11 isotope ion can be vaporized out of source on board said air-craft. The source being a brine solution from seawater, containing boron in the seawater, or a boric acid solution from borax from tincal from deposits in California or other parts of the world.

The remaining fuel source for the fusion reaction will be electrolyzed out of water or seawater, most likely on board said air-craft. The remaining fuel source will be constituents for the H-1 atom, protons and electrons, and with the B-11 isotope, ion, forming the fuel elements for the fusion process.

The referenced containment barrels for B-11 fuels for the fusion process, are barrels 142a, 142b, 142c and 144.

The maximum current to decompose said fuel solutions completely, to resulting particles desired, being protons, electrons, and the B-11 isotope ion, will be accomplished by two separate procedures, vaporization and electrolysis, can be accomplished on board the aircraft. Water for electrolysis is stored in barrel shaped containers. Platinum electrode is preferred material for electrolysis. Said electrolysis apparatus has what appears to be two arms, columns, on each side of individual barrel, except for said B-11 isotope ion column, which has an individual arm, column, projecting straight upward. The three barrels 142a, 142b and 142c, contain water, H2O. Said barrels of water will be electrolyzed by electrodes.

The B-11 isotope ion will be vaporized out of source, a boron source. Either boric acid from borax from tincal, or boron from a seawater source, a brine from seawater. Oppositely charged particles will exit each barrel, positive on one side, negative on opposite side. Though, not on the same side on all barrels. The B-11 isotope ion column will extend straight upward.

Sources for boron B-11 isotope ion includes seawater or borax. Borax is a compound found in nature as tincal. Tincal is available in millions of tons, over 200 million in California, a half billion in Turkey. It is also found in Tibet and many other countries of the world to include Russia. For the radiation free and direct conversion to electricity fusion reaction, boron B-11 isotope ion is required, uniquely. The hydrogen atom, H-1, is also required (H+ plus e−). The H-1 atom can be obtained from the electrolysis of water. Said tubular columns are also called tubes.

No fusion reaction is radiation free, the B-11 fusion reaction is conventionally referred to as a radiation free reaction. There is no significant radiation produced, or cooling required, using the fuels boron B-11 isotope and regular hydrogen. Energetic charged particles will be produced and stored within vortices.

Barrel 142a, FIG. 11B, contains a solution of H2O, water, for electrolysis by electrode. Said barrel is connected on one side to tubular column 111a. Said column is connected at the other end to ferromagnetic cored column within a column 112a. Said ferromagnetic column 112a is connected at the other end to exit electrode 154, FIGS. 11A and 11B. The positive sign under said electrode 154, indicates exiting electrode is a positively charged particle, in this instance, a positive proton. Said proton is moving in direction indicated by arrows in FIG. 11A. On the other side of said barrel 142a, said barrel is connected to tubular column 111b. Said column 111b is connected at the other end to ferromagnetic cored column within column 112b. Said ferromagnetic column is connected at the other end to exit electrode 160, FIGS. 11A and 11B. The negative sign, under said electrode 160, indicates exiting particle is a negative electron and moving in the direction indicated by arrows, FIG. 11A.

Barrel 142b contains: water for electrolysis by electrode 188.

On one side of barrel 142b, said barrel is connected to tubular column 111c. Said column is connected at the other end to ferromagnetic cored column 112c. Said ferromagnetic column is connected at the other end to exit electrode 152, FIGS. 11A and 11B. The negative sign under said electrode 152, indicates exiting particle is a negative particle, in this case an electron e−, and moving in direction indicated by arrows, FIG. 11A. Barrel 142b, containing water, is shown. On the other side of barrel 142b, said barrel is connected to tubular column 111d. Said column is connected at the other end of column 111d to ferromagnetic cored column within a larger column 112d. Said ferromagnetic cored column is connected at the Other end to exit electrode 164, FIGS. 11A and 11B. The positive sign indicates said exiting ion is a positive particle, a proton, and moving in direction indicated by arrow in FIG. 11A.

Barrel 142c, containing water for electrolysis by electrode 188, is shown. On one side of barrel 142c, said barrel is connected to tubular column 111e. Said column 111e, is connected at the other end to ferromagnetic cored column within a larger column 112e. Said ferromagnetic cored column is connected at the other end to exit electrode 156, FIGS. 11A and 11B. The positive sign under said electrode 156, FIG. 11A, indicates said exiting ion is a positive particle, a proton, and moving in the direction as indicated by arrows, FIG. 11A. Said barrel 142c, containing water, is shown. On the other side of barrel 142c, said barrel is connected to tubular column 111f. Said column 111f is connected at the other end to ferro-magnetic cored column 112f. Said ferromagnetic column is connected at the other end to exit electrode 162, FIGS. 11A and 11B. The negative sign, under said electrode 162, FIG. 11A, indicates said exiting particle is a negative particle, an electron, and moving in the direction as indicated by arrows, FIG. 11A.

Said electrodes on the roof of aircraft, FIG. 11A, are arrayed alternating from an electrode aperture charged to exit a proton, to an electrode charged to exit an electron at the next aperture. After exiting electrode, said oppositely charged particles will attract and form H-1 atoms, a fusion fuel. The remaining charged particles, B-11 isotope ions, will form a fuel constituent.

Rotational direction of particles on roof of aircraft, FIG. 11A, is in direction indicated by arrows. Said particles are in mini-Larmor orbits, said miniature, smaller orbits, are due to the charged particles being contained within said tubular columns, and constrained to orbit around the ferromagnetic columns contained in the center of some columns, as indicated. The resultant orbits around the ferromagnetic columns are referred to as mini-Larmor orbits, a contraction of the word, miniature. Said particles in said mini-Larmor orbits, upon exiting onto roof of aircraft, FIG. 11A, will initially begin forming funnel shaped spirals, and will be drawn into the forming spherical plasma 170, FIG. 12A, upper diagram.

The coordinated positioning and functioning of the three or more separate aircraft described in the field of invention or a single aircraft, and also described in the preferred embodiment for said aircraft, are proposed methods for arriving at a nuclear fusion reaction, and in-toto are the preferred embodiments for the number of aircraft required for the fusion process. The energy from one fusion reaction, can be absorbed by a multitude of aircraft, or even, one aircraft, within said aircraft rotating plasma vortices, on one aircraft or a multitude of aircraft.

The various aircraft used, have similar operating systems. The aircraft vary in size and material composition. The preferred embodiment for device A, A′, FIGS. 12A, 13 and 14, also known as aircraft 1, 1′, FIG. 1, is ferromagnetic chromium steel. The preferred embodiment for material for said larger aircraft, Device B and C, in FIGS. 12A, 13, 14 and 15, is magnesium aluminum material, a diamagnetic substance. The hulls of the larger craft will be magnesium aluminum material, the internal structure will be extruded magnesium aluminum. Aluminum has negligible magnetism. Both metals have low melting temperatures. Aluminum is a very good conductor of electricity, and can tolerate high electric temperatures as a result. Magnesium, next to titanium, is one of the strongest and lightest materials for aircraft. The ring assembly preferred embodiment, will be the same material for the large aircraft, as for the smaller ferromagnetic craft, tungsten, cobalt zirconium material.

As the applicant understands the law, only a method of building the invention, has to be proposed, or stated. It is not required for inventor to explain why it operates as it does, if it operates as inventor states. This invention will operate as stated. It will rise off the earth, and can be accelerated in a desired direction of travel. The craft may rise solely from the vortex action of the revolving plasma vortices. More than likely, the aircraft in the invention, rises from a combination of the large array of capacitors, arrayed in parallel, providing an initial lifting force in combination with the, plasma vortices. The strong magnetic force and electric force being factors. The presence, as stated of an abundance of plasma, and the presence of a plasma gun within craft, and an extensive array of capacitors in the aircraft, would suggest a combined propulsion system. The fluctuating direct current provides a strong pulsed current for the plasma gun. The vast array of capacitors arrayed in parallel, provides a strong magnetic field through the inductance coil in starting. The positive magnetic pole near, or in contact with the earth, provides a strong repulsive force against the earth. Upon rising of aircraft by these means, the ailerons can point the aircraft in the desired direction of travel, and the plasma gun can propel the aircraft in said direction.

After absorption of charged particles from said fusion reaction, by said plasma vortices, at that time, the vortices will propel the aircraft at the primary means of propulsion. Prior to said fusion reaction, the aircraft will produce from available energy in the ambient air, the plasma required to initially power said aircraft. The remnant energy within the capacitance and inductance systems will produce plasma on the annular ring. The large and small capacitors will produce at the same time, plasma for the plasma gun. The plasma vortices will increase in energy.

The larger, magnesium aluminum hulled, aircraft, bladed ring assemblies, by making contact, touching the hull of said highly magnetized Device A, will become equally, highly magnetized with said smaller aircraft, with no loss of magnetism to said smaller craft, after the fusion reaction.

The bladed ring assemblies 2, 2′, FIGS. 2 and 3, of Device B and Device C, comprised of tungsten cobalt zirconium material will be equally magnetized with bladed ring assembly of Device A. The plasma field of the aircraft, obtain energy from the applied magnetic fields. The bladed ring assemblies of the aircraft, comprised of tungsten, cobalt zirconium material, will raise the aircraft to high fields.

The top hull of the ferromagnetic hulled small craft, Device A, is required as the platform for the nuclear fusion process. The low melting point of magnesium and aluminum preclude their use as the base for the fusion reaction. The two billion degrees required for the fusion reaction will produce negligible heat, only electron volt temperatures are involved.

Spherical plasma can be formed on the roof of the magnesium hulled craft for operating energy, or to apply pressure from opposite sides toward the central fusion spherical plasma on the roof of the ferromagnetic hulled smaller craft. The non-fusion spherical plasmas are a potential source of operating energy for the aircraft, and can be mined for electricity by insertion of conducting rods, they are a potential energy source. They may persist for an indeterminate period of time, or the electrolysis system may produce, and tap electrons off onto electrodes for electricity.

A cone shaped pyramidal column 167, FIG. 11B, is located centered on roof of the smaller aircraft prior to beginning the fusion process. A glass ball electrode 169, FIG. 11B, preferred electrode embodiment for pyramidal cone, is situated on top of the pyramidal shaped column, 167. The ball electrode is slotted and air cooled. Raising the pyramidal cone with the ball electrode on top will induce an induced magnetic field on the roof of said smaller aircraft. An induced field within a larger applied magnetic field. By positioning two similar in operation, but larger in size aircraft on each side of the horizontal smaller aircraft A, A′, FIG. 12A, and perpendicular to the smaller aircraft, the fusion process can proceed. The positioning of the aircraft is required to obtain the pressure and temperature required for ignition of spherical plasma 170, FIG. 11B.

The larger aircraft on left side of horizontal aircraft A, A′, FIG. 12A, is perpendicular aircraft B, B′, FIG. 12A. The larger, craft on the right side of horizontal aircraft A, A′, is perpendicular aircraft C, C′, FIG. 12A. The larger aircraft will have spherical plasmas on the roofs of said aircraft. Said spherical plasmas are non B-11 ion spherical plasmas. They will not contain the boron B-11 isotope ion. Spherical plasma 174, FIG. 12A, is present on the roof of aircraft B, B′. Spherical plasma 178, FIG. 12A, is on the roof of aircraft C, C′. The fusion spherical plasma 170, FIG. 12A, is on the roof of aircraft A, A′. Spherical plasma 170 contains the fusion fuel boron B-11 isotope ion. Regular hydrogen atom, H-1, is contained within the fusion spherical plasma.

By positioning the large aircraft B, B′, and large aircraft C, C′, FIG. 12A, upper diagram, perpendicular to smaller horizontal air-craft A, A′, the two larger aircraft have thereby placed their spherical plasmas on top of the roof of the smaller aircraft A, A′. Spherical plasmas 178 and 174 now abut the fusion spherical plasma 170 from opposite sides, FIG. 12A, upper diagram. The fusion spherical plasma 170 is also within the tightening, smaller induced Larmor gyro orbiting particle field 182, FIG. 12A. There also exists an induced electric current 186, FIG. 12A. Said electric current contributes to temperatures required for ignition of fusion spherical plasma, and can be assumed to be receiving energy from emitted electromagnetic radiation from ball electrode 169, FIG. 11B.

The electromagnetic radiation 44, 44′, FIG. 5, emanates from the inductance coil 47, 47′, FIG. 5, part of the aircraft oscillatory circuit. The pyramidal cone shaped column 167, FIG. 11B, is placed over circular opening remaining after removal of hatch cover 23a, FIG. 5. The ball electrode 169, FIG. 12A, is placed on top of said pyramidal cone.

The bottom rotating plasma vortex 34′ of aircraft B, B′, FIG. 12A, and the bottom rotating plasma vortex 34′ of aircraft C, C′, FIG. 12A, by increasing their rotational rate are applying pressure from both sides to fusion spherical plasma 170, FIG. 12A, on the horizontal roof of device A. The rotational direction of plasma 174, FIG. 12B, is perpendicular to rotational direction of fusion spherical plasma 170, FIG. 12B, and is in the opposite direction to rotational direction of spherical plasma 178, FIG. 12B, of aircraft C. These opposing rotational directions added to the pressure from the rotating vortices squeezing the spherical plasma 174 and 178 into fusion spherical plasma 170, comprise part of the increased pressure and temperature.

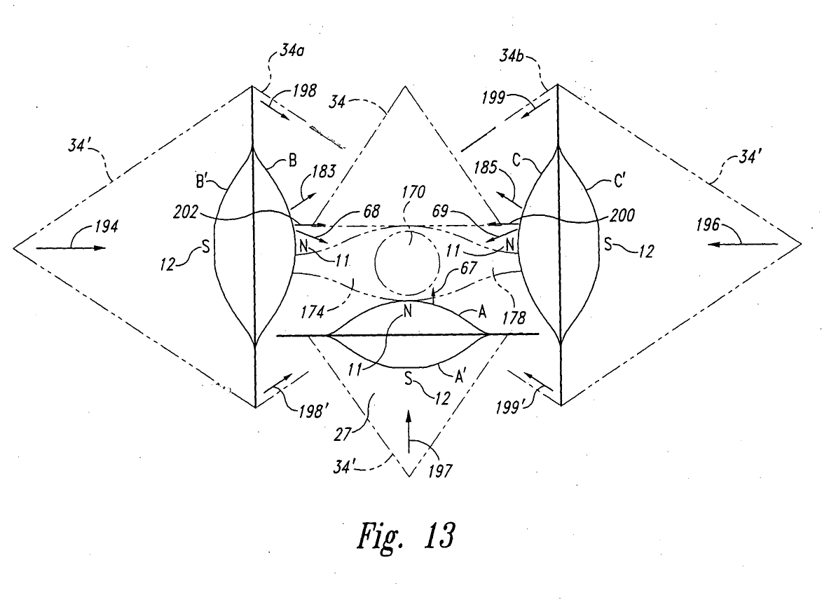

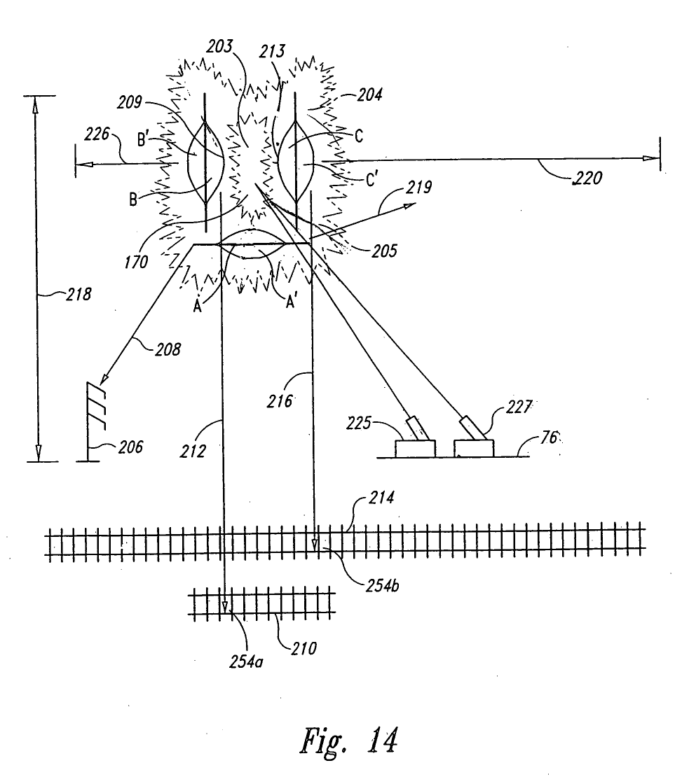

The tightening induced Larmor orbiting particle field 182, FIG. 12A has enveloped the spherical plasma 170, FIG. 12A upper diagram. The induced electric current 186, FIG. 12A, and adding the considerable number of orbiting charged particles within the induced Larmor field, and by adding gyro orbiting particles within said spherical plasma 174, 178 and 170, FIG. 13, conditions are nearing ignition temperature. And, with a final addition being, said Larmor field 182, side view, and 184, top view, FIGS. 12A and 12C, changed particles being squeezed into said fusion spherical plasma 170.

The rotating spherical plasmas 174 and 178, FIG. 12B, have also been squeezed into an amorphous mass around said fusion spherical plasma 170, best seen in FIG. 13. At the same time, magnetic fields 49a and 49b, FIG. 5, are now concentrating the three separate aircraft magnetic fluxes, all intersecting, with a resultant increase in thermal temperature. Heat is still being added from multiple sources. The rotating bottom vortices of device C, 34′, FIG. 13, and device B, 34′, FIG. 13, are still increasing pressure. There are extent, other pressure and heat sources. The bottom vortex 34′, of aircraft A, is pushing against repulsive magnetic forces 202, 67 and 69 from opposing north poles 202 and 206, FIG. 13, of the three aircraft.

The temperature and pressure for ignition is being approached. At the moment of ignition of fusion spherical plasma 170, there will be an appearance of flames, through it is primarily photon energy 203, rather than heat. It will appear like a flaming cylinder due to the two large aircraft B and C, being perpendicular, and the smaller aircraft, aircraft A, being horizontal, and the smaller aircraft, aircraft A, having instantaneously departed after ignition. The two large craft may appear to move even closer around the fusion spherical plasma, appearing as a single perpendicular flaming cylinder.

At the moment of ignition of fusion spherical plasma 170, there may be appearance of flames, through it is primarily photon energy. The three aircraft are grounded. Device A is grounded to a high power tension line. The two larger aircraft are grounded each to individual railroad tracks running in opposite directions. Device A is grounded by cable 208, FIG. 14, device B is grounded by cable 212, to railroad track 210, FIG. 14, device C is grounded by cable 216, to railroad track 214, FIG. 14. If said fusion spherical plasma does not spontaneously ignite from applied pressure and temperature, ignition can be accomplished with land based laser 227, FIG. 14, or the more potent neutral beam 225, FIG. 14.

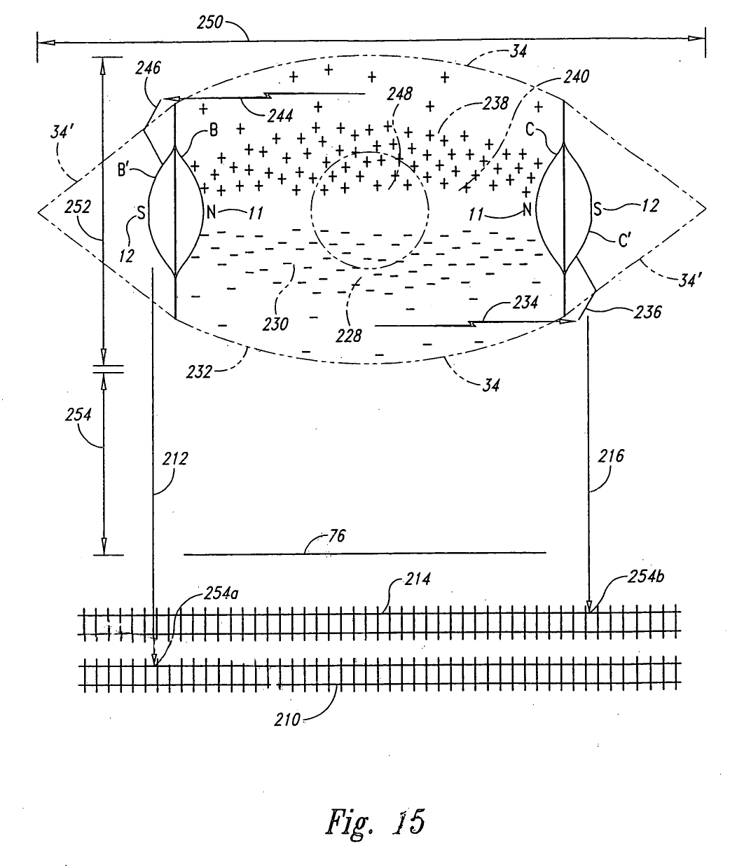

The end phase is shown in FIG. 15. The aircraft, device C will blown and move itself to the right approximately 120 feet, device B will be blown and move itself to the left 30 feet, aircraft A will have been blown, or will have moved itself 100 feet to the west of a north facing device B and a south facing device C, approximately behind the midsection of a large plasma cloud of moving charged particles. Said plasma would ordinarily be opaque, and not visible, unless ignition occurs prior to daybreak, or at dusk.

The particles created in the nuclear fusion reaction are within a moderately dark plasma cloud at daybreak, to be visible, and are positioned between the two large aircraft. A seeming failed attempt at organizing in the center 248, FIG. 15, of the plasma cloud, leads to a collapse of the plasma formation. What ensues is similar to an atmospheric phenomenon when a storm cloud collapses and lightning is produced. The two large aircraft, device B and device C, serve as collecting rods, in effect. Two large bolts of energetic charged particles, similar to bolts of lightning are produced. One bolt, approximately two feet in width and green in color goes to one craft, device B. Another bolt, normal lightning bolt color goes to the other craft, device C. It can be assumed the green bolt is positive charged particles, and the normal lightning colored bolt, is negative in charge. Or, the green bolt is comprised of electrostatic particles and the other bolt is energetic charged particles, predominantly negative in charge. Extended rods from each aircraft will collect the bolts. The energy can be stored within craft magnetic fields within the rotating plasma vortices, stored in an on-board superconducting ring, or transmitted to a power distribution center by microwave. Energy from the bolts can be grounded.

If an on-board superconducting ring is utilized, energy to reduce temperatures to permit superconductivity will not be a factor.

End of the operation of the process portion of this patent.

Beginning of description of the preferred embodiment for the process portion of this patent as it relates to a nuclear fusion reaction process or method for producing electricity from a nuclear fusion reaction without significant radiation produced or cooling required, using the fusion fuels B-11 and regular hydrogen atom, H-1, with nearly 100 percent efficiency.

The 11 in B-11 isotope ion is the neutrons, and, five protons, the correct designation for this isotope would be ¹¹boron. Conventionally, it is called B-11 isotope, or B-11. The hydrogen atom is one proton and one electron. It is referred to as H-1. The ion H+, a proton, is also the hydrogen atom, H-1, without an electron. The terms B-11, H-1, and H+ will be utilized.

Referring to FIG. 11A, a top perspective view of the top roof surface of aircraft device A, is shown insulated exit electrode apertures are shown. Electrode 156 is designated as positive by positive sign below said electrode. Electrode 156 is in reality negatively charged, the exiting particle is designated as positive by the charge sign by electrode 156. In the instant case, the particle exiting electrode 156 is a positive proton, a positive sign is shown in figure. Moving counterclockwise, for the next electrode 152, a negative electron exits. The next electrode, electrode 154, a positive proton exits. The next electrode 158, a B-11 isotope ion exits, and a positive, plus sign is indicated, and shown.

The next electrode 164, a positive proton exits. The next electrode 160, a negative electron exits. The next electrode 162, a negative electron exits. Positive B-11 isotope ion 158 will repel positive proton 164 and positive proton 154. Positive proton 164 will be attracted to negative electron 160 which is repelled by negative electron 162. Negative electron 162 will be attracted to proton 156, and negative electron 152 is attracted to proton 154, which is repelled by B-11 isotope ion 158, and the B-11 isotope ion alone, is unpaired.

When the applied magnetic field expands upward due to the induced magnetic field, the applied electric current may expand upward at the same time, more definitively, will expand upwards at the same time. At that time, the induced electric field will contain a strong induced electric current, contributing to temperatures required for ignition.

Referring to FIG. 11B, a cross section side view of device A is shown. A barrel shaped container of prepared B-11 isotope ion 144 is depicted in FIG. 11B. Said barrel shaped container is attached at one end to B-11 isotope ion tubular column 111g, and at the other end of column 111g, said column is attached to a ferromagnetic cored column within a larger tubular column 112g. Preferred embodiment for the bottom tubular column 111g, is laminated, translucent shock and fracture resistant glass. For upper ferromagnetic column 112g, preferred embodiment for glass, is the same fracture and shock resistant, translucent laminated glass. Said column 112g, is connected at the higher end to exit electrode 158. The barrel 144, contains isotope ion solution, said solution is a seawater brine, or boric acid, or other B-11 isotope containing solution. Said electrolysis system is best seen in FIGS. 11B and 12A.

Referring to FIG. 12A, upper portion of diagram, shown is a side view of the small aircraft, device A, positioned horizontal within the diagram. On the left side, device A, is large aircraft, device B, positioned perpendicular to device A. On the right side of device A, is large aircraft, device C, positioned perpendicular to device A. Shown on all three devices are north and southpole signs, N and S. Fusion spherical plasma 170 is shown positioned on top of device A. Non-fusion spherical plasma 174 is shown on the roof of device B. Non-fusion spherical plasma 178 is shown on the roof of device C. On each side of fusion spherical plasma 170, is depicted induced Larmor gyro orbiting plasma particle field 182. Said induced orbiting plasma field, the induced particle field, is increasingly applying tightening pressure to the fusion spherical plasma 170.

Centered within the fusion spherical plasma 170 is a raised pyramidal column 167. Said column is positioned on top of roof of small aircraft, device A. Ball electrode 169 is positioned on top on said pyramidial cone. The ball electrode is comprised of heat resistant glass with slotted apertures. The pyramidal cone is an extension of the underlying electric coil, also called

Inductance coil 47, 47′, FIG. 5.

Raising the pyramidal cone, induced a magnetic field. Within said induced magnetic field is induced Larmor gyro orbiting plasma particle field 182, FIG. 12A, upper diagram. Also present is an induced electric current 186, FIG. 12A, upper diagram. Said induced electric current, within the induced electric field, possesses a concentration of energetic charged particles at the midpoint of fusion spherical plasma 170, FIG. 12A, upper diagram.

The non-fusion spherical plasmas are shown on each side of fusion spherical plasma 170. Said non-fusion spherical plasma 174, FIG. 12A applies pressure from the left side to center fusion spherical plasma 170. The non-fusion spherical plasma 178 applies pressure from the right side to fusion spherical plasma 170, the center spherical plasma. Plasma vortex 34′, bottom vortex of device B, and also plasma vortex 34′, bottom vortex of device C, are applying rotational propulsion pressure toward center fusion spherical plasma 170, from both sides of plasma 170.

Referring to FIG. 12A, lower diagram. Said lower diagram in FIG. 12A, is identical to FIG. 11B. Said lower diagram is positioned below upper diagram, FIG. 12A, to provide a frame of reference to identify the central, horizontal figure, device A, within upper diagram, FIG. 12A, by means of the common pyramidal cone 167. Said reference point, the pyramidal cone, is the sole reason for said lower diagram being present in FIG. 12A. Said abstract upper diagram in FIG. 12A, is able to be comprehended as an aircraft, only by means of this common point of reference.

Referring to FIGS. 12A and 12B, in FIG. 12B the rotational direction of spherical plasmas 174, 170 and 178, are shown. Viewing the three spherical plasmas from the center plasma 170, the left spherical plasma 174, is rotating in the opposite direction to spherical plasma 178 and rotating perpendicular to fusion spherical plasma 170. The three spherical plasmas are rotating in different directions. Said varying rotational directions are a contributing factor toward the increasing temperature required for ignition. Frictional heat is caused by the varying rotational directions of the three touching spherical plasmas. More specifically the two non-fusion spherical plasmas, in contact with the central fusion spherical plasma. Also, upon absorption of the three plasmas by amalgamation, the interior rotating particles will be, initially, rotating in different directions, resultant collisions will increase temperature required for ignition.

Additionally, spherical plasma 174 and 178 are being pressed into the center fusion spherical plasma 170, from both sides, by the propulsive force of the bottom rotating plasma vortices of device B and device C, represented by arrows 196 and 194, FIG. 13.

Referring to FIG. 12C, a side view of said induced Lamor orbiting particle field 182, is shown in FIG. 12C. The fusion spherical plasma 170, FIG. 12A, upper diagram, is completely encircled by the tightening induced particle field 182, at this stage. Said Larmor orbiting particle field 182, FIG. 12C, will have pressured itself into fusion spherical plasma 170, as the adjacent non-fusion spherical plasmas 174 and 178, FIG. 12B, are pressured into the fusion spherical plasma 170, as depicted in FIG. 12A, upper diagram, at start of process, and in FIG. 13, at end of process.

Referring to FIG. 13, a side view of device A, device B and device C, is shown. Aircraft B, also called device B, is positioned perpendicular to horizontal device A, and is located to the left of device A. Device C is perpendicular to device A, and is located on the right of device A.

Device A, is horizontal to earth. The fusion spherical plasma 170 on top of device A, is now surrounded by an amorphous mass consisting of spherical plasma 174 and 178. The rotational energy of device B, bottom vortex 34′, is directed toward spherical plasma 170 as indicated by arrow 194. The rotational energy of device C bottom vortex 34′, is directed at spherical plasma 170 as indicated by arrow 196. The rotational energy and pressure of device A bottom vortex 34′, is directed at spherical plasma 170, the fusion plasma, by arrow 197, and is also directed against opposing magnetic north pole 68 of device B, and repulsive north pole 69 of device C, by the repulsive north pole force 67 of device A.

Remnant organizing rotational force directed toward the fusion spherical plasma 170 from device B top vortex 34, is represented by arrow 198, and from device C top vortex 34, represented by arrow 199, and from device B, top vortex 34, represented by arrow 198′, and from device C top vortex 34, represented by arrow 199′. Plasma propulsion 27, can be used to augment lesser rotational force of device A vortex 34′, as compared to device B and device C. Repulsive magnetic north pole force 202 from top of device B is directed as indicated by arrow 183. Repulsive magnetic north pole force 200 from device C is directed as indicated by arrow 185.

The most notable event in on-going fusion process is the absorption of induced Larmor gyro orbiting particle field 182 into fusion spherical plasma 170. The orbiting particle plasma field 182 is composed of rotating highly energetic particles increasing in energy to the speed of light. This energy has now been added to the equally energetic rotating particles within the fusion spherical plasma 170. The orbiting particle plasma field 182 is composed of rotating highly energetic particles. This energy has now been added to the equally energetic rotating particles within the fusion spherical plasma 170.

Incrementally, the process is approaching a two billion degree temperature needed for ignition, utilizing the fusion fuels boron B-11 isotope ion and regular hydrogen. Depicted in FIG. 13 is the absorption of induced electric current 186, FIG. 12A, into the fusion spherical plasma 170. Within a short period of time, the amorphous mass encircling fusion spherical plasma 170, shown in FIG. 13, will also be compressed into said spherical Plasma. The amorphous mass, including spherical plasma 174 and the other non-fusion spherical plasma 178, and induced Larmor orbiting particle field 182, FIG. 12A, upper diagram, contains considerable energy. The aircraft are accompanied by a circular magnetic field around the bladed ring assembly of each device. The intersecting magnetic rings of each device will concentrate their magnetic flux with a resultant increase in temperature, and increase in temperature of the fusion spherical plasma.

Referring to FIG. 14, at moment of ignition 203, FIG. 14, there will be an appearance of flames 204, FIG. 14, around the fusion spherical plasma 170, though it is primarily photon radiation, and relatively harmless, and possessing negligible heat. Photon radiation appears, at times, almost identical to normal flames. A large quantity of energetic charged particles are being created by the fusion reaction. The ferromagnetic horizontal device, device A, FIG. 12A, will ground itself to hi-tension power line 206 by cable 208, FIG. 14. The large perpendicular device, device B, with an opposing north pole 209 facing north pole 213 of device C, will ground itself to railroad track 210 by cable 212. Large perpendicular device, device C, will ground itself to railroad track 214 by cable 216. Cable attachment systems can be remotely attached, and disengaged electronically, or by physical means, such as grappling hooks which automatically open when gravity released, or close when pulling up against gravity. The three devices, device A, device B and device C, are approximately 110 feet above the earth 76, at reference number 218, FIG. 14. At the moment of ignition of said fusion plasma, the smaller aircraft, device A, will be moved, as well as move itself, 100 feet in the direction indicated by arrow 218, to behind the developing plasma cloud 230, FIG. 15. Prior to ignition of fusion spherical plasma, the three aircraft will be close together, almost contiguous. The large perpendicular aircraft, device C will be blown and move itself 120 feet to the right as indicated by arrow 220. The perpendicular aircraft, device on the left, will be blown and move itself 30 feet to the left as represented by arrow 226.

If necessary, ignition can be accomplished with high power laser 227, or the more potent neutral beam 225. Preferred embodiment for the number of aircraft utilized with said laser or neutral beam, is a single ferromagnetic aircraft, though three aircraft, to include said two large aircraft, and the small aircraft, is also recommended. Any number of aircraft can participate within the ignition process, any reasonable number.

Referring to FIG. 15, the end phase of nuclear fusion reaction is shown. Negative ions and particles 228, FIG. 15, attracted to positive charged earth 76, collect on the bottom of plasma cloud 230. After the plasma cloud breaks down in a failed attempt to organize spherically 248, in the center of plasma cloud 230, as indicated by said weakly organizing sphere 248, in the center of plasma cloud 230, the energetic charged particles slow in a failed attempt to organize into a spherical plasma. The plasma collapses due to insufficient energy to maintain its organizing effort.

The plasma cloud formative energy comes from the magnetic fields of device B and device C and from the fusion reaction energy. In this case, the energetic particles created by said fusion reaction have been stored in magnetic plasma fields 34, 34a, and 34′ 34a′. Negative particles 228, FIG. 15, attracted to positive charged earth 76, collect on the bottom of plasma cloud 230. On the top of plasma cloud 230, FIG. 15, positive particles and electrostatic particles 238, collect, having been repelled by assumably positive charged earth 76. A Langmuir sheath 232, envelopes the entire plasma.

There is a space 240, FIG. 15, between negative and positive charges. The positive charges being repelled by positively charged earth, as a rule, and the negative charges being equally attracted by both the earth and positive charges above. The approximate width of the cloud is 150 feet, as indicated by arrow 250, FIG. 15. It is still a plasma cloud, composed of positive and negative charges, electrostatic particles and moving charged particles, but still enveloped by said Langmuir sheath 232, FIG. 15. After breakdown of organizing effort by plasma 248, a bolt of green electricity, like lightning, as represented by pointed arrow 244 will strike extended rod 246, said rod extending out from of top of aircraft, device B. An equally wide, approximately one and one-half foot wide, bolt of normal colored electricity 234, will strike extended rod 236, extending out from device C. Said electric bolts, electricity, can be stored within craft plasma fields 34, 34′ and 34a, 34a′, or, if plasma vortices are already filled to capacity, said bolts can be grounded to earth, or the excess can be grounded.

It is assured the ferromagnetic craft will have the potential to store energy after ferromagnetism is lost. The magnesium aluminum hulled large craft will have almost unlimited potential to store said created energy.

Said fusion produced energy can also be stored within an on-board superconducting ring, or microwaved to a land based superconducting ring, as energy for cooling to obtain required superconducting temperature for materials used, will not be a factor.

The height of said plasma formation, plasma cloud, is indicated at reference number 254, FIG. 15, will be approximately 70 to 80 feet, as shown in FIG. 15. It is assumed the north pole 11 on large device C will be located as shown in FIG. 15, as that is the orientation of said north pole at time of fusion ignition. Said craft would not have had time to change said orientation. The same applies to device B and north pole 11,

Ground cable 216 from device C on right connects to railroad track 214. A remote magnetic release, preferred embodiment, disengages ground cable connection 254b. A grounding device 212 from device B on left is connected to railroad track 210, FIG. 15. A remote release 254a, disengages ground cable 212 from railroad track 210, FIG. 15, in preferred embodiment for remote cable grounding release device.

The horizontal ferromagnetic aircraft, device A, has been located behind the opaque plasma cloud, approximately 100 feet from fusion reaction location.

Said aircraft plasmas 34, 34′ and 34a, 34a′, FIG. 1, are able to store all the fusion energy produced, as said plasmas are able to store said energy with almost unlimited capacity to store said produced fusion energy, in said rotating plasma vortices.

The penultimate achievement of this fusion system was realized when the induced Larmor orbiting particle field tightens around said fusion spherical plasma 170, FIG. 12A, upper diagram, and then said induced Larmor orbiting particle field is surrounded by said electric current 186, FIG. 12A, upper diagram, and further surrounded by said raised applied field electric current 14, FIG. 11A, said current combines with, and into said induced field electric current, and is surrounded by said applied field Larmor orbiting particle field 34, 34a and 34′, 34a′, FIG. 1. Said applied Larmor orbiting particle field also tightening with time, and now tightening around all of said surrounding fields. The necessary pressure and temperature for ignition will be reached. In the event, that it is not reached, ignition can be accomplished by means of said hi-power laser, and, or neutral beam. The small aircraft mill be required to use the plasma gun to remain aloft, due to loss of said applied field electric current. During said stationary, vertical condition, craft ailerons can be used to stablilize craft.

After the aircraft loses its ferromagnetism due to high fields, the plasma will undergo a seeming change in its shape. This is due to the craft electric field increasing around the tungsten based annular ring of blades, and the craft magnetic field around said blades, though it will still possess the same north and south pole orientation, said magnetic field is now oriented around the annular ring of blades, as opposed to the previous orientation around the aircraft. Said new magnetic field will stretch beyond the end of the ring of blades, and consequently, said aircraft plasma field will also stretch out at the ends of said ring of blades, the annular ring of blades. The electric field now determines the aircraft plasma shape, the electric field In the diamagnetic plasma, and the electric field, particularly, around said annular ring of blades, with its now altered plasma configuration.

With loss of ferromagnetism, the aircraft will still be able to fly though some loss of altitude may result in a temporary requirement for readjustment.

1. A nuclear fusion process utilizing a smaller ferromagnetic aircraft and two or more larger magnesium aluminum aircraft, to produce energetic charged particles, a method to accomplish ignition of a formed fusion spherical plasma with two or more larger magnesium aluminum aircraft, and a method to contain and store said produced fusion energy, mostly energetic charged particles,
said nuclear fusion reaction can only take place at high temperatures, which this nuclear fusion reaction system will achieve, this fusion reaction system will reach temperatures required for said nuclear fusion reaction, wherein, the reacting nuclei will have the high energies needed to overcome mutual electrostatic force of repulsion, which is, the repulsion exerted by a charged particle on another charged particle, and this system will contain all of the energy produced within the top and bottom vortices of said aircraft, FIG. 15.

2. The method of claim 1, wherein a method to accomplish ignition of said fusion spherical plasma with two or more larger aluminum hulled aircraft, comprises the steps of:
(a) positioning said two or more larger magnesium aluminum hulled aircraft, perpendicular and opposing on each side of said fusion spherical plasma, and also, said larger craft, perpendicular to said smaller ferromagnetic hulled horizontal aircraft, relative to earth 76, FIG. 14, and by,
(b) positioning the rotating plasma vortices on the top surfaces of the three aircraft, touching, whereby,
(c) the top rotating plasma vortex on the larger aircraft will be intersecting, each vortex will be rotating in a different direction, FIG. 12B,
(d) each of said aircraft will possess a formed spherical plasma, the smaller aircraft spherical plasma, alone, possesses a fusion spherical plasma 170, FIG. 12A, upper diagram,
(e) said induced magnetic field has raised the top rotating plasma vortex of said smaller aircraft, above said induced, and, or, expanded magnetic field.
(f) top plasma vortices of said two larger aircraft are directly intersecting,
(g) the plasma vortices of the two larger aircraft are now exerting pressure on the central fusion spherical plasma, from opposite sides,
(h) said fusion spherical plasma is now completely, encircled by tightening induced Larmor orbiting particle field 182, FIG. 12A, upper diagram,
(i) and, said tightening induced Larmor orbiting particle field around said fusion spherical plasma, is now surrounded by induced electric current 186, FIG. 12A, upper diagram, squeezed into and with applied field electric current 14, FIG. 11A, bereft of said applied field electric current, said small craft is using the craft plasma gun 64 to stay aloft, using said craft ailerons to stabilize craft, said applied field electric current was raised when applied magnetic field expanded at time induced magnetic field induced,
(j) and, said induced-tightening electric current with said raised applied field current, is now surrounded by said applied field Larmor orbiting particle field 34, 34a and 34′, 34a′, FIG. 1, released and drawn in by said induced magnetic field, and now tightening around said combined electric currents and said induced Larmor orbiting particle field beneath said electric currents, and all of said currents and fields are now applying pressure and increasing temperature on said underlying fusion spherical plasma,
(k) each of said spherical plasmas is rotating in a different direction FIG. 12B,
(l) each of said spherical plasmas is comprised of rotating charged particles, the particles in each plasma are rotating in different directions than the particles in the other spherical plasmas,
(m) and, only the center fusion spherical plasma contains the B-11 isotope ions,
(n) if ignition does'not spontaneously occur, hi-power laser can be utilized to effect ignition, and neutral beam can be utilized to effect ignition,
(o) prior to beginning fusion process, said large craft have to be grounded to separate locations, two separate sets of railroad tracks as indicated in FIG. 14, said smaller aircraft is grounded to a hi-power tension line in FIG. 14, said grounding attachments can be attached and disengaged remotely in preferred embodiment,
(p) whereby, ignition of said fusion spherical plasma will be effected, all aircraft being grounded as indicated in FIG. 14,
(q) moment of ignition is indicated in FIG. 14, after,
(r) said large aircraft are almost instantaneously moved to locations indicated in FIG. 15, the high magnetic fields produced by said fusion reaction, will immediately render the ferromagnetic craft vulnerable to loss of said craft ferromagnetism, thereby necessitating immediate departure of said smaller ferromagnetic aircraft at moment of ignition, to a distance of approximately 200 feet.

3. The method of claim 1, wherein a method to contain and store said produced fusion energy, mostly one energetic charged particles, within said plasma vortices of said larger magnesium aluminum hulled aircraft, comprises the steps of:
(a) after said nuclear fusion reaction, said larger aircraft, aircraft B and Aircraft C, also called device B and device C, will store said produced fusion energy, energy, mostly energetic charged particles, within said aircraft plasma vortices, energy is stored continuously,
(b) as said aircraft move with the expanding plasma formation as it expands as shown in FIG. 15, until final dissolution of said plasma formation 230 also called plasma cloud, at which time, remaining energy, mostly electrostatic particles, will be absorbed by oppositely charged rods extending from each craft,
(c) upon final collapse of said plasma formation, a bolt of positive, green electricity will be attracted to outstretched lightning rod of negatively charged rod, and a bolt of usual colored negative electricity will be attracted to outstretched positive rod, said final bolts of electricity can be stored or grounded,
(d) all of said produced fusion energy has been stored in the plasma vortices of said aircraft B and aircraft C,
(e) said produced energy can remain stored in said aircraft vortices, as plasmas are capable of storing an almost unlimited amount of energy, or,
(f) said energy can be microwaved or sent by waveguide to an energy storage location.
